(19) United States
(12) Patent Application Publication
(10) Pub. No.: US 2006/0031112 A1
(43) Pub. Date: Feb. 9, 2006

(54) Business simulator method and apparatus based on clinical workflow parameters

(76) Inventors: Axel Barth, Erlangen (DE); Dieter Boing, Muhlhausen (DE); Gregor Malischnig, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/912,891

(22) Filed: Aug. 6, 2004

(51) Int. Cl. G07G 1/00

(52) U.S. Cl. 705/10; 705/2

(57) ABSTRACT

The present invention provides a method and apparatus for simulating a medical facilities utilization of technical medical equipment. Comparisons of patient workflow for different equipment and software configurations can be performed and comparisons of workflow and other performance factors can be made between a particular medical facility and other medical facilities are available for comparison purposes. Budgetary constraints are taken into consideration. A business report is provided which may be utilized by the potential purchaser of medical technical medical equipment for an analysis of its own facility or may be utilized by sales personnel to promote sales of upgraded or new hardware and software.

### BACKGROUND OF THE INVENTION

1. Field of the Invention

The present invention relates generally to an apparatus, method and computer for simulating and analyzing a customer's product needs, and in particular, to a computer simulator and method for analyzing medical clinic workflow parameters relative to its needs for technical medical equipment.

2. Description of the Related Art

Customers, particularly customers looking to purchase technical medical equipment as a substantial investment, may have no tools by which to evaluate their needs for such technical equipment, particularly as it relates to comparing their needs to other users of such technical medical equipment or to the efficiency with which such costly equipment is used. An examples of technical medical equipment includes computer tomography equipment. Currently, sales people and market engineers discuss the needs of a customer with the customer and attempt to suggest products to the customer based upon the customer's perceived needs.

### SUMMARY OF THE INVENTION

The present invention provides a technical tool by which the needs of a customer or potential customer of, for example, technical medical equipment, are evaluated. In particular, a business simulation computer is provided as a tool for determining the needs of a customer by consideration of a customer profile of the customer. The profiles of a plurality of customers which have been obtained are combined into clusters and a determination is made as to which technical medical system is likely to meet the future needs of a customer by comparison to others in a particular cluster of customer profiles. According to one embodiment, a business report is prepared for the customer to identify at least one scenario of technical medical equipment, and preferably several scenarios of technical medical equipment, which meets the customers needs.

### BRIEF DESCRIPTION OF THE DRAWINGS

FIG. 1 is a schematic illustration of a system for simulation and analysis of clinical workflow parameters;

FIG. 2 is a graph of pricing recommendations for utilization management of technical medical equipment;

FIG. 3 is a graphical illustration of variance and likelihood of purchasing for technical medical equipment;

FIG. 4 is a graph of information utilized in benchmarking the needs of a customer relative to the utilization management of technical medical equipment with the needs of other medical equipment customers; and

FIG. 5 is a graph of needs for utilization management for technical medical equipment.

### DETAILED DESCRIPTION OF THE PREFERRED EMBODIMIENTS

Medical facilities, such as hospitals, clinics, doctors offices, public health care facilities, medical centers, health services centers, etc., utilize technical medical equipment in diagnosing and treating patients. Such technical medical equipment includes devices such as computer tomograph (CT) equipment, also referred to as computerized axial tomography (CAT) scan devices, Magnetic Resonance Image (MRI) scanners, etc. These devices tend to be expensive and careful consideration must be given to their purchase and use in order to effectively use these resources and obtain the greatest return on investment. Not only is hardware considered here but software purchases must also be considered. The purchasing decisions are not limited to acquisition of new equipment and software but also include upgrades to existing equipment and software. Other large investments and equipment purchases are included here as well. Further, the present invention need not be limited to medical facilities, but may be applied anywhere substantial acquisitions are being considered.

Administrators of these medical facilities may be limited in their experience in purchasing these costly technical devices and generally have no way to compare the needs at their facility to other facilities or to an ideal or optimized utilization of such devices.

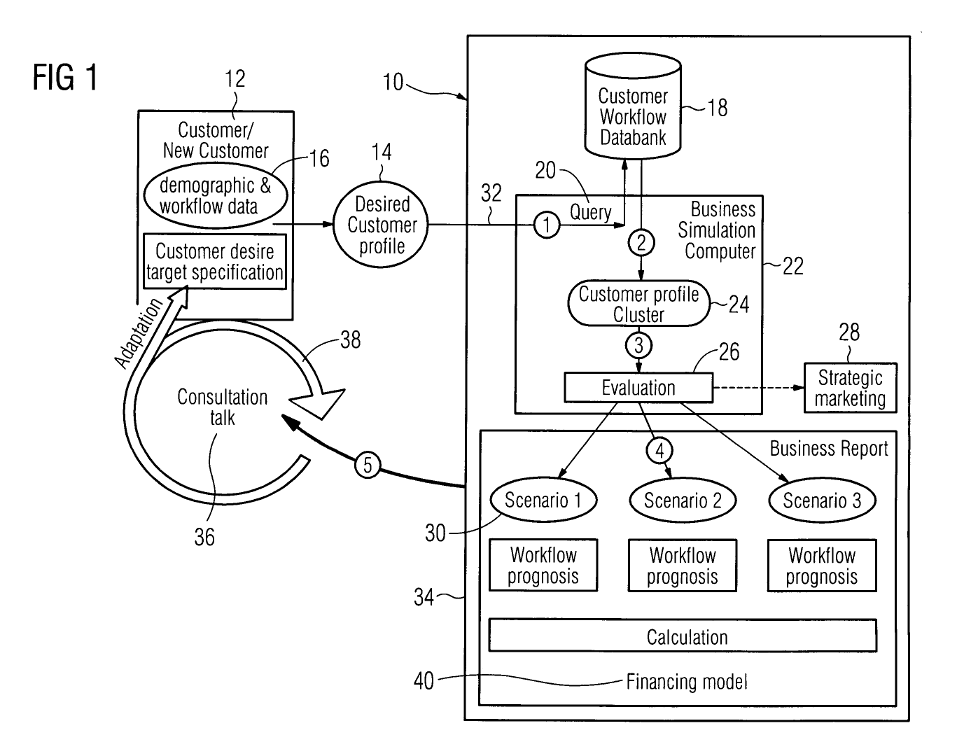

The present invention provides a business simulation computer 10 by which a customer of technical medical equipment analyzes its needs for hardware and software configurations and purchases in a cost-effective manner. With reference to FIG. 1, the business simulation computer 10 is a central component of the present system which determines for a customer 12 (or potential customer or for purchasing agents acting on behalf of the customer) which configuration of a technical medical system (such as a computer tomography scanner) is individually adapted to the needs of customer's facility and may be under consideration for purchase within an available budget. A customer profile 14 is generated by imputing information relating to the customer, such as demographic data and workflow data 16, to a customer profile databank 18 for storage. The customer profile 16 includes information on patient workflow through the customer's medical facility and may be generated in response to a query 20. A computing portion 22 of the business simulation computer 10 primarily communicates with the customer workflow database 18 in which customer profiles are stored.

The customer profiles are the result of an automatic workflow analysis which has been performed to analyze the workflow of the customer and to benchmark the workflow of the customer against other similarly situated customers. A desired customer profile 14 for the purchasing agent is used in the business simulation computer 10 as a query criterion for the customer workflow database.

The customer profiles are retrieved from the database 18 and combined into cluster information 24 in the business simulation computer 10. The cluster 24 is a grouping of similarly situated users of the technical medical equipment. The customer profiles are compared to satisfy at least the requirements of the desired customer profile to form the cluster 24. From the cluster 24, the business simulation computer 10 determines the best suited other customer profiles to present to the customer regarding scenarios 30 which approximate the future system configuration needs of that customer. An evaluation 26 of the customer's desired performance for the technical medical equipment is performed, leading to a marketing strategy 28. Possible scenarios 30 within the scope of the present invention include cost/use optimization of the equipment, capacity optimization of the equipment, or investment minimization expended for the equipment.

It is important that the business simulation computer 10 can access the current data of the workflow analysis for the customer. The timeliness of the information relating to the installed systems of the customer and other workflow related issues is ensured via the use of a central server in a computer network 32 that is in communication with the customer and others involved in the acquisition decision.

The business simulation computer 10 functions are described in the following. FIG. 1 illustrates the processes of the business simulation computer 10 functions in further detail. In particular, under part 1, demographic and workflow data 16 of a new customer or prospective customer is obtained. This can include a customer profile and information on the specific needs of the customer. Demographic data is also obtained. The demographic data includes the type of installation being considered, including an identification of established radiologists, city clinics in the area, university clinics in the area, the size of the hospital, the category of the hospital, such as whether it is a private or a state hospital, the number of scanners available in the hospital, the product group or product type of scanners currently used in the hospital (such as whether the scanners are high-end, medium, or low-end scanners), the number of workstations available, the archiving system available, whether the hospital is a specialized medical center, such as for children, cancer care, emergency care, etc., the number of technical medical radiological assistants, etc.

The workflow data which is accumulated for the new customer or prospective customer in the customer profile includes a reproduction of the workflow of the operating processes on the computer tomograph scanner or other scanner. These include the patient positioning times, examination times, dead times, the contrast agent quantity that is administered to the patient for specific tomograph examinations. These data are recorded and statistically processed. The examination focus for the examinations should also be identified, such as whether the examination is a cardiac computer tomograph scan, emergency computer tomograph scan, neuro computer tomograph scan, and standard head and body computer tomograph scan.

The demographic data and workflow data form the customer profile 14. A desired customer profile is generated by the data obtained in response to questions 20 asked of the customer during a consultation talk with the customer. This desired customer profile, also designated 14, is drawn upon as a query of the customer workflow databank. The desired customer profile 14 is designed to be similar to the customer profiles of the installed equipment base that is stored in the database for the customer workflow databank 18. The customer profiles stored in the databank 18 differ from the desired customer profile in that the actual customer profiles are based on real measured processes that originate from automatic monitoring of the customers. As such, the customer's desired profile can be compared to actual customers to determine if it is feasible. The business simulation computer initially works with default customer profiles prior to actual customer profiles being stored in the databank for use in the comparison. These can be expanded or new customer profiles can be defined in the databank 18. A new customer profile is established or a desired profile occurs after a direct consultation with the customer or potential customer.

A new customer or a new potential customer of a technical medical device communicates the customer's demographic data and its ideas about performance targets with regard to, for example, examination bandwidth, patient throughput and investment levels for the new equipment. For a customer that is upgrading an installed configuration, an existing customer communicates target ideas with regard to examination bandwidth, patient throughput and level of investment for the upgraded equipment.

The present invention, in a preferred embodiment, utilizes clustering. Clusters 24 are groupings of similarly situated customers, in other words, a group of customers with similar customer profiles. The larger a cluster, the more representative it is for comparison with desired customer profiles. Large clusters are also suited for application of additional filter criteria in order to adapt it exactly for comparison to a customer with regard to hardware and software configurations or for other criteria, such as information concerning minimum patient throughput.

An evaluation 26 is performed according to the present system Clusters 24 which are provided are forwarded to the business simulation computer 10 for evaluation according to specific criteria. From this evaluation 26, scenarios 30 are created which represent possible system configurations for the customer. Examples of such scenarios are provided as follows, although others are of course possible. According to one scenario, a cost verses use optimization is performed. Here consideration is given as to which scanner installation achieves the greatest use at the lowest possible costs. The particular product type of the medical scanner in this situation plays only a secondary role. A second scenario is for capacity optimization. In this scenario, the maximum capacity for a product type is the focus when the maximum patient throughput requirement is foremost in consideration. The third scenario involves investment minimization. This is where a customer has a limited budget available and must deal with the most suitable product variant that is available yet can still meet the budget.

According to another aspect of the invention, a business report 34 is generated for the customer. The business report 32 displays the scenarios 30 visually for consideration by the customer. Depending upon the interest expressed by the customers, one of the scenarios may be preferred. The scenarios 30 which are processed in the business report 34 include a specific number of customer installations that can be prioritized according to specific criteria, such as load capacity, product lifespan or product life cycle costs, or amortization of the product costs.

The business report 34 may also include a cost calculation for the equipment acquisition or upgrade and a model for custom financing for the customer, as well as a graphical representation of the work flow prognosis that are described in a co-pending application by the same assignee. As desired, the best practice customers are defined by comparison with other customers and these can be referred to as reference customers.

A consultation talk 36 with the customer 12 is performed according to an aspect of the invention. The foregoing points are specifically addressed during the consultation talk and the consultation talk is to be understood as an iterative process 38. The customer 12 is counseled on the basis of the business report 34. New goals are worked out that lead to new scenarios 30 until the desired ideas of the customer is fulfilled.

Strategic marketing is performed utilizing the business simulation computer, which also offers the possibility of eliciting triggers (which are inputs for strategic marketing) based upon specific circumstances that may occur, which are in turn evaluated by marketing personnel and may elicit targeted actions such as an arrangement of a customer visit. Possible trigger events may include an end of product support. The end of support trigger is executed before the termination of the product life cycle. A sales associate is automatically informed about when a customer is considering a possible new acquisition.

A further triggering event is hardware or software licensing renewal. The renewal of hardware or software licensing is an incident that triggers a signal to the sales associate that a hardware or software upgrade should be effected for a customer the renewal occurs after the expiration of a specified time that corresponds with the conclusion of the service contract.

Automatic monitoring of the customers workflow is a further aspect of the present invention. This is accomplished by connection to the customer's facility through a network connection 32. The business simulation computer may be configured to determine under which circumstances the foregoing triggers are initiated. Furthermore, the business simulation computer should implement an automatic bottleneck recognition. Bottlenecks which are the result of hardware which has insufficient capacity or which are due to the lack of available software options should be detectable. A transparent representation of these bottlenecks will show to the customer that additional investments via upgrades of hardware or software are worthwhile. The advantages which result from the technical features which are set forth above include improved customer support.

A tool is provided for sales of technical medical equipment using the business simulation computer 10. With this tool the quality of consultation regarding the capacity of the medical facility can be significantly improved through the use of a business report 34. Transparency is increased and customers can better comprehend the sales arguments. A goal is to analyze the documented results of the business report with the customer in a mutual conversation. Changes in the input data immediately affect the business report and possibly also lead to a configuration of a system being individually adapted to the customer in a way that is optimized both as to the workflow requirements and as to the economic situation or budget of the customer.

Since the business simulation computer 10 obtains its results from the workflow analysis of the equipment installations, the results can be checked by the purchasing agents or the customers. Contacts to facilities with existing installations of the equipment being considered can be produced if desired. With the aid of the present business simulation computer 10, the customer 12 can be counseled as to which system configurations, both as to hardware configurations and software configurations, have already been proven to work well with other customers that have similar customer profiles.

In one example, a question can be addressed as to how a computer tomograph customer in a university medical facility implements cardiac examinations with a high-end computer tomograph. As a potential new customer, the customer receives information regarding the cost effectiveness of the desired product. The potential for increasing efficiency can be shown to an existing customer during a consultation talk. Since the customer profiles can be defined dynamically, leeway is available to present different scenarios to an interested party. Naturally, the budget available for new acquisitions or upgrades of technical equipment also plays a decisive role in the decision as to which technical equipment may be purchased and as to which computer tomograph product a customer may prefer. Also of importance in the purchasing decision is an analysis of the product life cycle.

The business report 34 of the present invention aids in the making of objective decisions. Using the business report, the customer receives objective aids in making the decision regarding the investment in the technical medical equipment by an objective comparison to existing installations. As an alternative, the business reports of existing customers can be accessed for consideration or benchmarking of their service capacity or for development of decision aids for potential new customers during a consultation discussion.

The present invention may also be utilized for amortization and financing models 40. An important consideration for a customer is when will the investment be amortized and what are the expected operating costs of the technical medical equipment during the product life (also referred to as product life cycle costs). These questions can be answered by looking at tendencies in the customer profile by comparison with similar customer profiles of installations which are already in place. It is important that a representative quantity of installed systems are available in the business simulation computer for comparison purposes. Country specific peculiarities may also be taken into account by filtering the quantity of installed systems according to these criteria, such as using a refined customer profile. This ensures that the financing models and operating costs calculations are correctly applied from existing installations by the business simulation computer. It is thus possible to present to the customer an individually customized financing model for the acquisition of the technical medical equipment.

Comparison calculations can also be performed by the present invention. Software versions, hardware expansions as well as software options, can be compared to one another with regard to what effect they may have on efficiency of the installed base, for example by using before and after models. It is also possible to compare systems of different clusters of customers to one another. This comparison can lead to conclusions about whether an installation with a specific software option may operate more efficiently than one that does not yet have this specific software option, for example. Comparisons can be made with regard to resource efficiency, bottlenecks caused by the software, load statistics, etc.

The product life cycle can be analyzed using the present invention. In particular, a product life cycle cost analysis is performed. The analysis of the product life cycle costs for different systems is used to transparently illustrate the consequence comparisons for potential new customers.

The present system utilizes reference customers as information resources. Contacts can be arranged between the customer and existing installations that serve as reference customer, as desired. Such reference customers can only be established with a mutual understanding between the reference customer and the seller. It is thus possible for a potential customer interested in purchasing a computer tomograph, for example, to inquire of the reference customers about the clinical use and the cost effectiveness of specific products. For instance, the potential customer may have questions about the level of patient throughput which is possible with a particular technical medical system.

The present invention is used to provide medical facilities with new installations of technical medical equipment and/or to provide existing customers that already have such equipment with upgraded software and/or hardware for their technical medical equipment. Additional facilities may be targeted for consulting services using the present developments, particularly as relates to patient workflow and effective use of applications. Further, an additional option is to provide scalable usage fees via an expanded utilization management, which here is embodied in the business report.

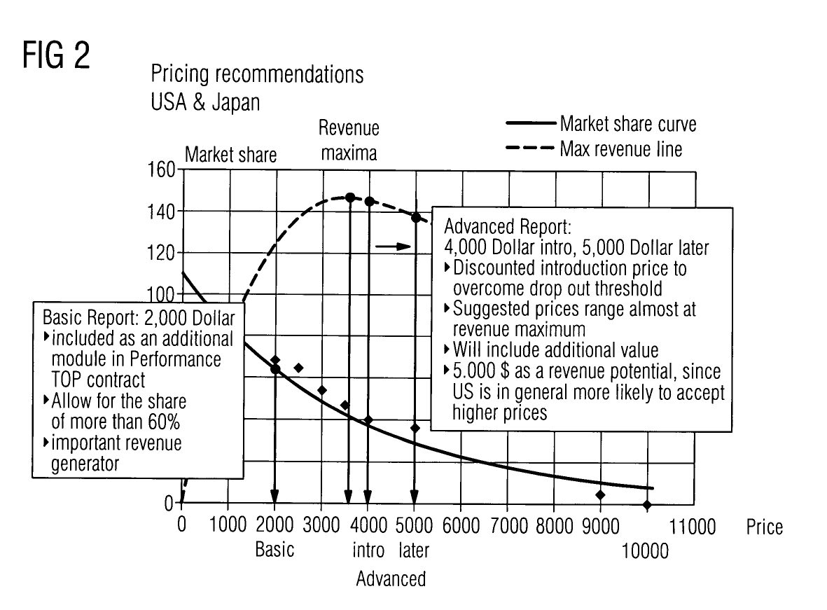

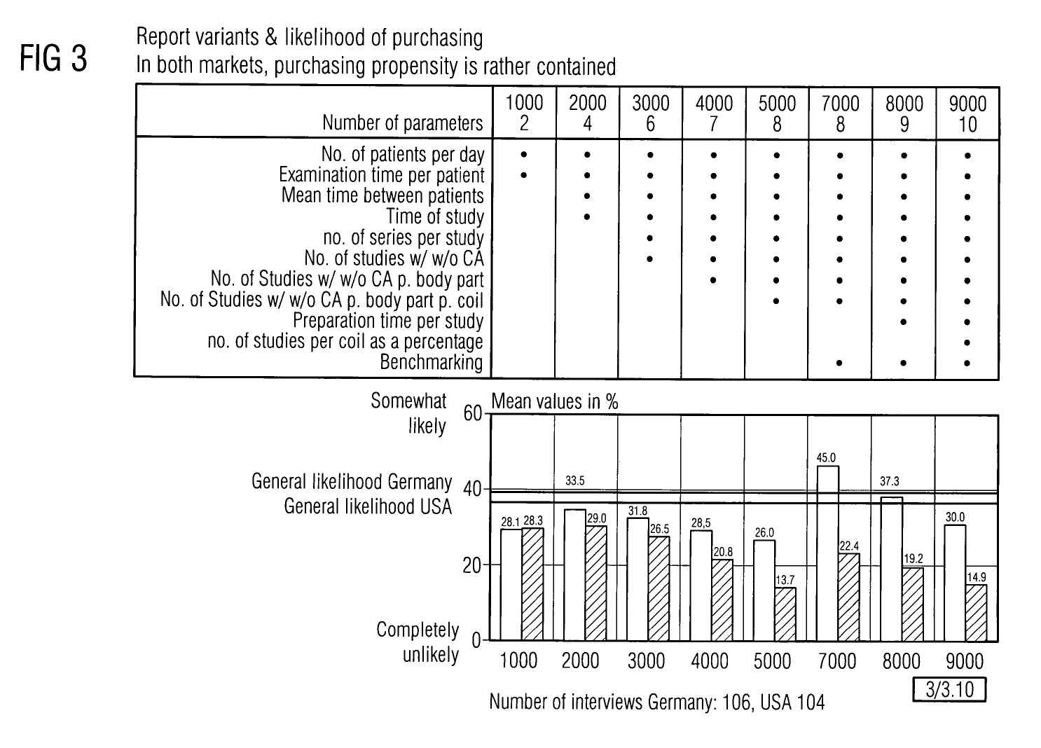

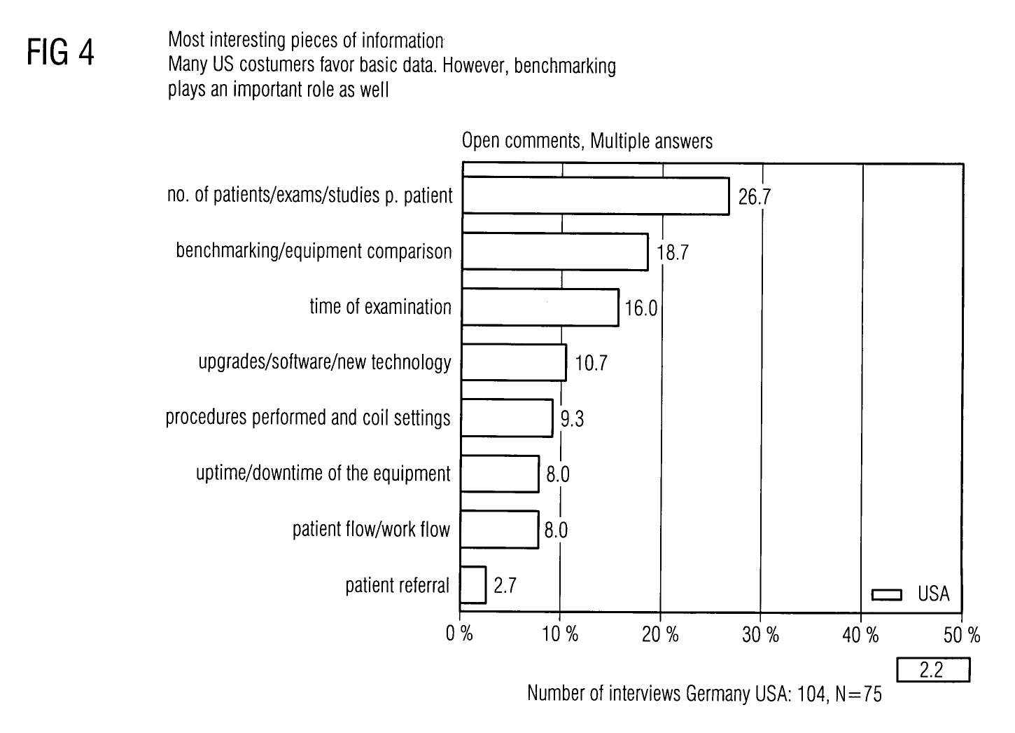

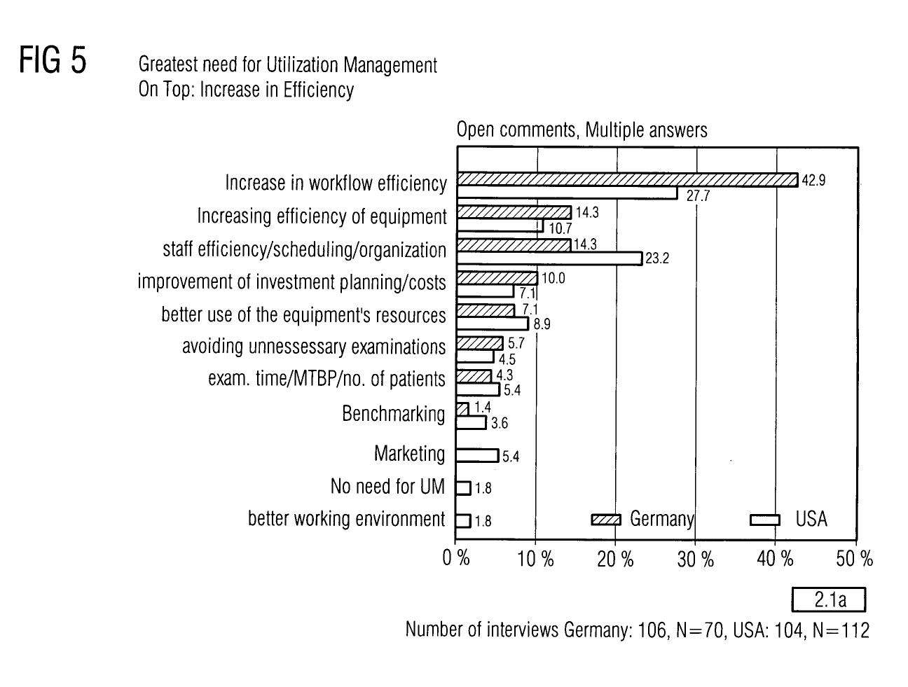

A study that has been conducted of the cost-effectiveness of utilization management using business reports which reveals that customers are particularly interested in transparency of the clinical workflow and analysis of improvement potentials. Compare FIGS. 4 and 5, particular as to the top five items in the ranking list. From the noted study, it is further revealed that respondents in Japan and the United States would readily pay $5,000 or more a year for technical medical equipment use statistics and for the possibility to benchmark their clinical workflow data against others. Compare FIGS. 2 and 3.

With the present invention it is possible to create individually customized system configurations for a customer which takes into account both the workflow aspects and the available budget of the customer.

It is possible with the present invention to provide greater transparency of information and targeted preparation for a sales session using a business report prepared according to the present invention.

The present invention provides better argumentation aids relative to the concurrence.

Although other modifications and changes may be suggested by those skilled in the art, it is the intention of the inventors to embody within the patent warranted hereon all changes and modifications as reasonably and properly come within the scope of their contribution to the art.

We claim:

1. A business simulation computer for a medical facility as a customer of technical medical equipment, comprising:
a communication between a customer or potential customer and the business simulation computer via which information on the customer or potential customer is communicated to the business simulation computer, said information including workflow information and demographic information on the customer or potential customer;
a customer databank including a data storage for storing data regarding the customer or potential customer and for storing data regarding a plurality of further customers or default customer profiles;
a customer profile of the customer or potential customer obtained by query of the customer databank;
a cluster of customer profiles, said cluster including said customer profile of the customer or potential customer grouped with profiles of similar ones of said further customers or default customers;
a business report generated for the customer or potential customer relating to at least one of acquisition of new technical medical equipment and upgrade of existing technical medical equipment, said technical medical equipment of said business report being common to substantially all of said customers of said cluster.

2. A business simulation computer as claimed in claim 1, wherein said communication between the customer or potential customer and the business simulation computer is via a network connection.

3. A business simulation computer as claimed in claim 1, wherein said information on the customer or potential customer is obtained automatically by monitoring the customer or potential customer.

4. A business simulation computer as claimed in claim 1, wherein said business report includes a plurality of scenarios for future operation of the medical facility of the customer or potential customer.

5. A business simulation computer as claimed in claim 5, wherein said scenarios include at least one scenario chosen from: a cost/use scenario, a capacity scenario, and an investment minimization scenario.

6. A business simulation computer as claimed in claim 1, wherein said technical medical equipment includes at least one of: hardware and software.

7. A business simulation computer as claimed in claim 1, wherein said technical medical equipment includes a medical scanner.

8. A business simulation computer as claimed in claim 1, wherein said technical medical equipment includes a computer tomography scanner.

9. A business simulation computer as claimed in claim 1, wherein generation of said business report is initiated by a triggering event.

10. A business simulation computer as claimed in claim 9, wherein said triggering event is one of: a customer visit, an end of support, a service renewal, and a workflow event threshold.

11. A business simulation computer as claimed in claim 1, wherein said business report includes a comparison of the customer or potential customer with at least one similar further customer in said cluster.

12. A business simulation computer as claimed in claim 1, wherein said business report includes at least one of: a recommendation of workflow for the customer or prospective customer, a product life cycle analysis, an amortization model, and a financing model.

13. A method for providing technical medical equipment to a medical facility as a customer or potential customer, comprising the steps of:
gathering demographic and workflow information on the customer or potential customer relating to the use of technical medical equipment;
comparing the demographic and workflow information on the customer or potential customer with further medical facilities to identify those further medical facilities that are similar to the customer or potential customer with regard to technical medical equipment;
grouping the customer or potential customer with said similar further medical facilities;
generating a business report based on findings of said grouping, said business report including information on the technical medical equipment of the similar further medical facilities; and
providing said business report to said customer or potential customer relating to acquisition of new or upgraded technical medical equipment.

14. A method as claimed in claim 13, wherein said business report includes a plurality of scenarios relating to new or upgraded technical medical equipment for the customer or potential customer.

15. A method as claimed in claim 13, wherein said business report includes cost calculations and financial model information concerning the acquisition of new or upgraded technical medical equipment.
